(19) United States
(12) Patent Application Publication
(10) Pub. No.: US 2005/0039783 A1
(43) Pub. Date: Feb. 24, 2005

(54) Wafer transfer system of wet cleaning equipment

(76) Inventor: Ju-Hyun Nam, Suwon-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 10/919,413

(22) Filed: Aug. 17, 2004

(30) Foreign Application Priority Data
Aug. 22, 2003 (KR) 2003-58176

(51) Int. Cl. B08B 3/00

(52) U.S. Cl. 134/66; 134/78; 134/902

(57) ABSTRACT

A wafer transfer system for use in a wet cleaning equipment frequently checks the state of alignment of wafers while the wafers are transferred between a plurality of baths. The system includes at least one transfer robot a sensor and a controller. The plurality of baths are disposed adjacent one another in one line. The transfer robot has a robot chuck that can hold a plurality of the wafers and is driven to transfer the wafers into and from each of the baths. The sensor is oriented to face the direction in which the wafers are held by the chuck at a sensing area outside of the baths. The sensor is thus operable to detect the state of alignment of flat zones of the wafers. The controller receives a detection signal from the sensor and controls respective components of the equipment, such as the transfer robot, if an alignment error is determined to exist.

### BACKGROUND OF THE INVENTION

1. Field of the Invention

The present invention relates to wet cleaning equipment for cleaning semiconductor wafers. More specifically, the present invention relates to a wafer transfer system for transferring wafers between a plurality of chemical baths.

2. Description of the Related Art

Semiconductor devices are generally manufactured by selectively and repetitively performing respective unit processes such as photolithography, etching, diffusion, chemical vapor deposition, ion implantation and metal deposition processes. These processes produce at least one or more conductive layers, semiconductor layers and insulating layers on a wafer. Furthermore, each unit process is typically followed by a respective cleaning process for removing impurities from the wafer, e.g., a layer of undesirable material, byproducts of the reaction created during the unit process, or various kinds of foreign substances.

The cleaning process is classified largely into a wet type and a dry type. A conventional wet type of cleaning equipment 10 and process will be described with reference to FIGS. 1 and 2a-2c.

Referring first to FIG. 1, a plurality of wafers W are mounted in a cassette C and the cassette C is placed in a loading station 12 of the cleaning equipment 10. Next, a conveyer (not shown) sequentially conveys the cassette C to a first counting device 14 for checking the number of wafers W in the cassette C, an aligning device 16 for aligning flat zones of the wafers W in one direction, and a separating station 18 at which the wafers W are removed from the cassette C.

The cassette C is lowered at the separation station 18, whereby the plurality of wafers W are received, respectively, in a plurality of slots of a support 20. At this time, the wafers are supported in a vertically upright state. The plurality of wafers W now separated from the cassette C are transferred by one or more transfer robots R1˜Rn to a plurality of chemical baths 22a, 22b, 22c, . . . , 22n. The chemical baths contain etchants of different properties and composition ratios.

The cassette C is then raised from the separating station, is moved to a re-loading station 24, and stands by at the re-loading station. The wafers W that have been cleaned are then re-loaded into the cassette C at the re-loading station.

A deionized(DI) water bath 26 is also provided between the separating station 18 and the re-loading station 24. Also, the chemical baths 22a, 22b, 22c, . . . , 22n and a drying section 28 are disposed in line with the DI water bath 26. The transfer robots R1˜Rn in this line individually transport the wafers W between the plurality of chemical baths 22a, 22b, 22c, . . . , 22n, the DI water bath 26 and the drying section 28. The wafers W are supported by a respective slotted support 20 disposed at the bottom of each bath 22a, 22b, 22c, . . . , 22n, 26. Accordingly, the wafers W are subjected to a respective unit cleaning procedure in each bath while in a vertically upright state. Finally, once the wafers W have been transferred by the transfer robots R1˜Rn through the plurality of chemical baths 22a, 22b, 22c, . . . , 22n, the deionized water bath 26 and the drying section 28, the wafers W are loaded into the cassette C that is standing by on the re-loading station 24. Next, the wafers W are transferred by a conveyor to a second counting device 32 and to an unloading station 34.

The number of the wafers W counted by the second counting device 32 is compared with the number of wafers W counted by the first counting device 14 to determine whether a wafer W did not make it through the line. If such a missing wafer W′ were allowed to remain in the line, e.g., on the support 20 within a chemical bath 22b as shown in FIG. 1, it could damage many of the wafers W subsequently conveyed into contact therewith. Furthermore, such transfer problems lower the productivity of the cleaning process.

These problems are caused by a wafer alignment error. As shown in FIG. 2a, a flat zone portion of a wafer W′ held by a transfer robot R1˜Rn may be skewed by a given angle opposite the support 20 in the bath 22a, 22b, 22c, . . . , 22n, 26. In this case, the wafer W′ will be set on the support 20 in a position deviating from the aligned array of other wafers W on the support 20, as shown in FIG. 2b. This error, in turn, causes the wafer W′ to collide with a robot chuck R/C of the next transfer robot R1˜Rn whereby the wafer W′ is broken or otherwise damaged. Furthermore, the collision may also damage the robot chuck R/C which could cause alignment errors with respect to the wafers W subsequently transferred by the damaged chuck. Also, the robot chuck R/C of the transfer robot R1˜Rn exerts pressure on and supports both sides of the wafer. Therefore, if the flat zone of the wafer W′ is laid across the robot chuck R/C, as shown in FIG. 2c, the wafer W′ can be dropped by the chuck R/C back onto the support 20 during the course of its transfer from the support 20.

Of course, the occurrence of these problems can be checked for by using the second counting device 32 to count the number of the wafers W that have been re-loaded into the cassette C. However, other wafers W transferred through the line can continue to be broken or otherwise damaged during the time it takes for the second counting device 32 to confirm the number of wafers that have been loaded into the cassette C.

### SUMMARY OF THE INVENTION

Accordingly, an object of the present invention is to provide wet cleaning equipment that frequently checks the state of alignment of the wafers while the wafers are being held and transferred so that the wafers can be prevented from being damaged.

To achieve this object, the present invention provides a wafer transfer system that includes at least one transfer robot, a sensor and a controller. The transfer robot includes a robot chuck that is configured to hold a plurality of wafers as spaced apart from one another in a given direction, and a driving mechanism that drives the chuck to transfer the wafers into and from each of the baths of the wet cleaning equipment. The working envelope of the transfer robot also includes a sensing area located outside at least one of the baths. The sensor is oriented to face the wafers in the given direction in which the wafers are arrayed once the wafers are taken out of a chemical bath by the transfer robot and are positioned at the sensing area. There, the sensor generates a signal indicative of the state of alignment of flat zones of the wafers. The controller receives the detection signal from the sensor and controls respective components, such as the transfer robot, when the controller determines that an alignment error is present

The sensor may comprise at least one photo-coupler including a light-emitting element that emits light along a light path extending in the direction in which the wafers are held by the robot chuck, and a light-detecting element disposed across from the light-emitting element. Preferably, the light-emitting and light-emitting elements are mounted to brackets on opposite sides of the baths.

The light path extends across the sensing area proximate the flat zones of the wafers. The controller can determine the state of alignment of the wafers by analyzing the amount of light received by the light-detecting element, namely by determining whether any of the light is blocked between the light-emitting and light-detecting elements of the photo-coupler. A pair of the photo-couplers may be provided side-by-side, such that light is emitted proximate the respective sides of the flat zones of the wafers. Alternatively, two pairs of the photo-couplers may be provided, one of the pairs being disposed side-by-side at an upper portion of the sensing area, and the other of pairs being disposed side-by-side at a lower portion of the sensing area. Thus, the sensor is capable of selectively determining whether the flat zones of the wafers are aligned at an upper position or a lower position.

Also, the sensor may comprise a CCD (charge-coupled device) camera instead of the photo-coupler(s). In this case, the CCD camera is disposed at one side of the baths, and a support such as a bracket is disposed at the other side of the baths. The support bears a mark across the sensing area from the CCD camera. The mark can be picked up by the CCD camera and discriminated when the flat zones of the wafers are aligned. Preferably, the CCD camera is mounted to a support shaft of the transfer robot so as to move therewith.

### BRIEF DESCRIPTION OF THE DRAWINGS

The present invention will become more fully understood from the detailed description made hereinbelow with reference to the accompanying drawings wherein:

FIG. 1 is a schematic diagram of wet cleaning equipment according to the prior art;

FIG. 2a is a front view of a robot chuck of a transfer robot of the prior art wet cleaning equipment, illustrating a wafer alignment error;

FIG. 2b is a front view of a wafer support in a bath of the prior art wet cleaning equipment, illustrating a result of the wafer alignment error

FIG. 2c is another front view of the robot chuck, illustrating a wafer alignment error that can result in the wafer being dropped by the chuck;

FIG. 3 is a side view of an essential part of a wafer transfer system of wet cleaning equipment according to the present invention;

FIG. 4 is a front view of a robot chuck of the system shown in FIG. 3;

FIG. 5 is a side view illustrating another embodiment of a wafer transfer system of wet cleaning equipment according to the present invention; and

FIG. 6 is a front of a robot chuck of the system shown in FIG. 5.

### DETAILED DESCRIPTION OF THE PREFERRED EMBODIMENTS

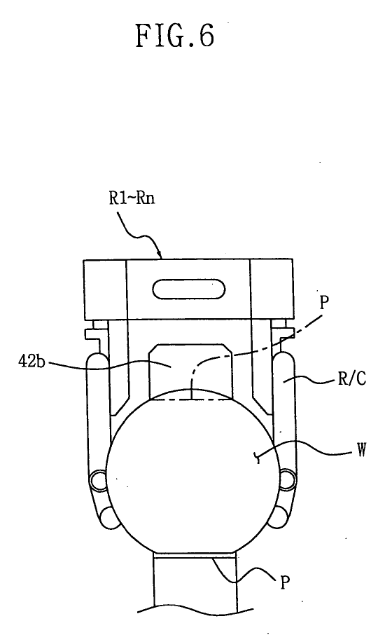

The preferred embodiments of the present invention will be described in detail hereinafter with reference to FIGS. 3 to 6. In the figures, like reference characters designate like parts throughout the different views. Also, a detailed description of known functions and systems has been omitted from the figures for the sake of clarity.

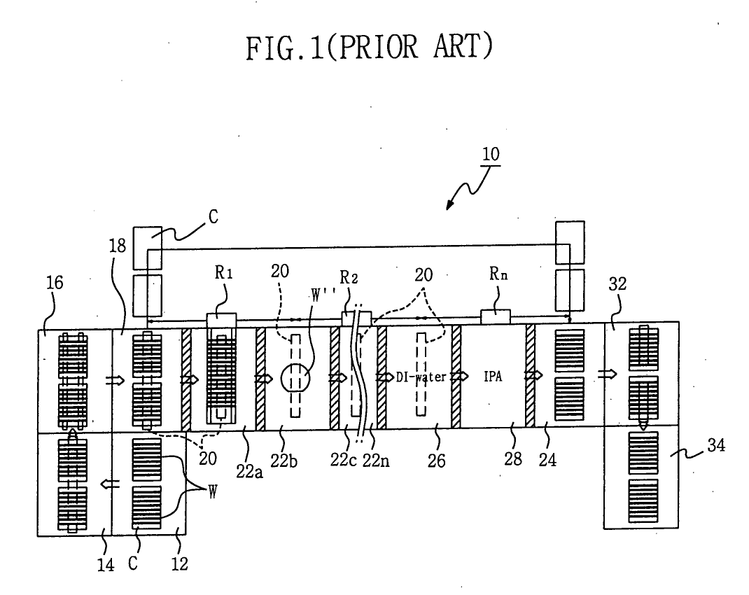

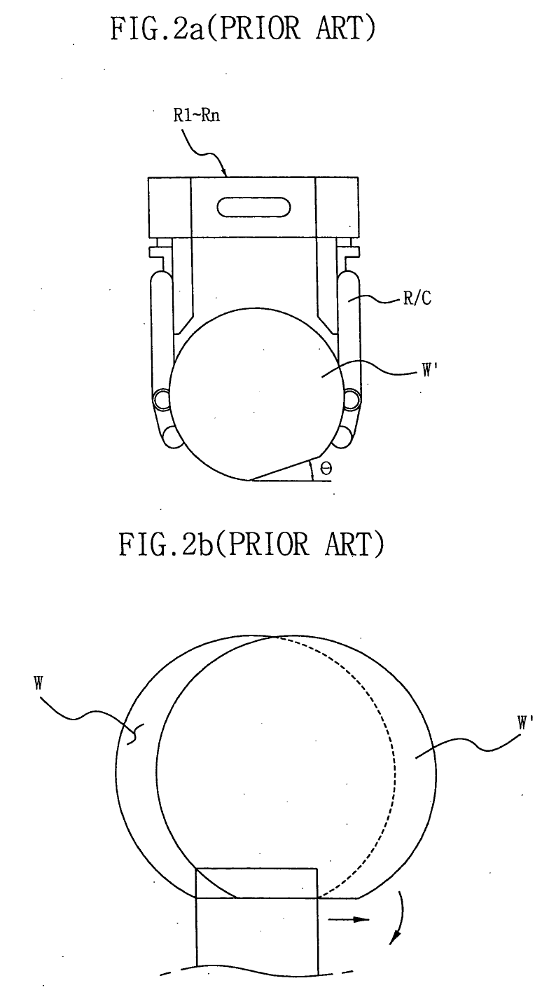

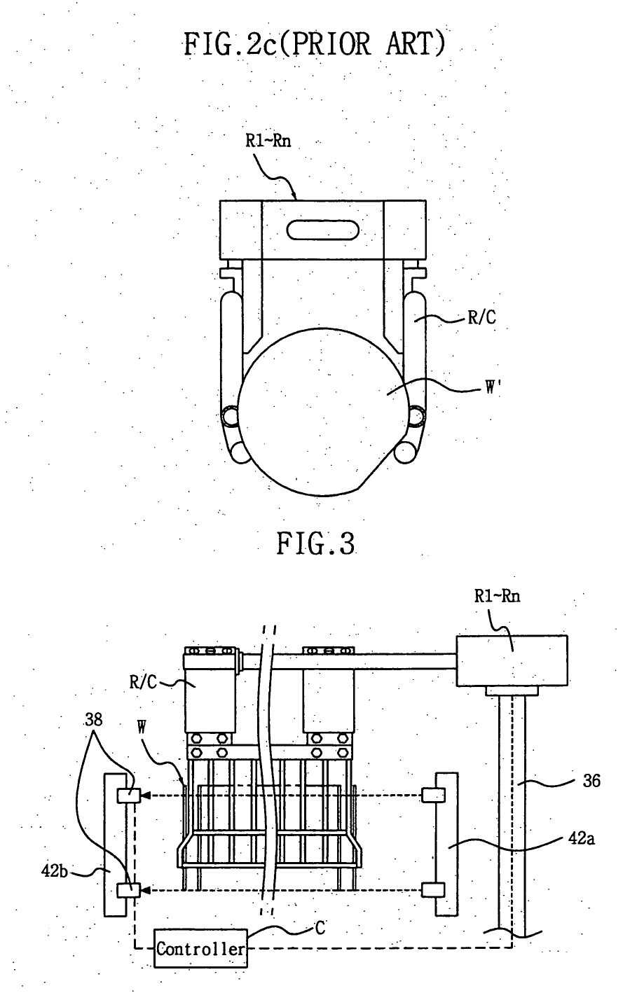

The present invention has generally the same configuration shown in FIG. 1, namely, a separating station 18 for removing wafers W from a cassette C, a re-loading station 24 at which the wafers W are re-loaded back into cassette C, a plurality of chemical baths (22a, 22b, 22c, . . . , 22n), a deionized water bath 22n and a drying section 28 disposed in line between the separating station 18 and the re-loading station 24, and a wafer transfer system. The wafer transfer system comprises at least one transfer robot R1˜Rn for transferring the wafers W from the separating station 18, through the plurality of baths (22a, 22b, 22c, . . . , 22n), to the drying section 28, and to the re-loading station 24.

Referring to FIG. 3, the transfer robots R1˜Rn each include a robot chuck R/C having a gripper that exerts and holds both sides of a number of wafers W, and an elevating mechanism having a support shaft 36 that supports the robot chuck R/C. The robot chuck R/C positions the wafers W in a corresponding bath (22a, 22b, 22c, . . . , 22n, 26) by virtue of the vertical movement of the support shaft 36. More specifically, the wafers W are submerged in the bath (22a, 22b, 22c, . . . , 22n, 26) and are transferred by the chuck R/C onto a slotted support 20 disposed in a lower portion of the bath (22a, 22b, 22c, . . . , 22n, 26). The wafers W are left in the bath for a predetermined period of time sufficient to complete the unit cleaning process. During this time, the transfer robot R1˜Rn is in an elevated stand-by position or in a position in preparation for transferring a next batch of wafers W to the support 20. Once the unit cleaning process is completed, the transfer robot R1˜Rn or another transfer robot R1˜Rn lifts the wafers W from support 20 in the bath (22a, 22b, 22c, . . . , 22n, 26).

The wafer transfer system also includes sensor disposed at the side of a sensing area where the wafers W are positioned once the wafers are taken out of the chemical bath (22a, 22b, 22c, . . . , 22n, 26) by the transfer robot R1˜Rn. More specifically, the sensor may comprise supports 42a, 42b, and photo-couplers 38 mounted to the supports 42a, 42b. The supports 42a, 42b may be a plurality of brackets 42a, 42b extending vertically upright at opposite sides of a bath (22a, 22b, 22c, . . . , 22n, 26). The support shaft 36 may be used instead of the bracket 42a to support respective components of the photo-couplers 38 so that the sensor is not interfered with by the vertical movement of the shaft 36. In any case, the photo-couplers 38 are located at a position aligned with the wafers W held by the robot chuck R/C at the sensing area to detect whether flat zones of the wafers W are aligned. Each photo-coupler 38 includes a photo-emitter for emitting detection light, namely, laser light, along a light path, and a photo-detector confronting the photo-emitter so as to receive the light transmitted along the light path.

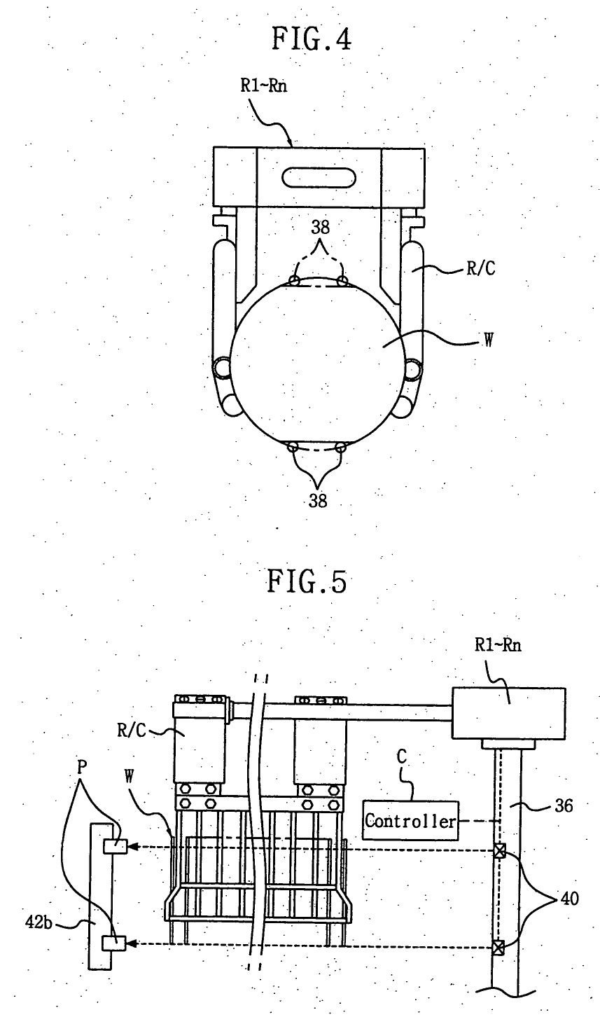

The light path is not blocked by the wafers W when the wafers W are all disposed in a given orientation with the flat zones of the wafers W aligned. On the other hand, an alignment error can be determined to exist when the quantity of light detected by a photo-detector is different from the quantity of light emitted by the corresponding photo-emitter. As shown in FIG. 4, a pair of photo-couplers 38 may be provided at locations corresponding to the sides of the flat zones of the wafers W when the wafers are at the sensing area. Alternatively, two pairs of the photo-couplers 38 may be provided, one pair being disposed at the top of the sensing area and the other pair being disposed at the bottom of the sensing area to selectively detect whether the flat zones of the wafers W are aligned at the upper side or lower side of the robot chuck R/C.

According to another embodiment of the invention as showing in FIG. 5, the sensor may comprise a CCD camera 40 for photographing the wafers W at the sensing area. The CCD camera 40 may be installed on the support shaft 36 of the elevating mechanism of the transfer robot R1˜Rn or on a dedicated support disposed to the side the corresponding chemical bath (22a, 22b, 22c, . . . , 22n, 26).

A reference position of the CCD camera 40 is aligned with the direction in which the wafers W are arrayed when held by the robot chuck R/C at the sensing area. Furthermore, the CCD camera may also be supported so as to be raised or lowered relative to the sensing area so that the CCD camera can discriminate between the case in which the flat zones position of the wafers W are aligned at the upper side of the robot chuck R/C and the case in which the flat zones of the wafers W are aligned at the lower side of the robot chuck R/C.

In addition, a vertically upright bracket 42b may be provided opposite the CCD camera 40, namely, on the opposite side of the corresponding bath (22a, 22b, 22c, . . . , 22n, 26). The bracket 42b bears a mark P. Accordingly, an image of the mark P is taken by the CCD camera 40 when the flat zones of the wafers W are aligned. On the other hand, an image of the mark P is not visible to the CCD camera 40 if even one wafer W is misaligned. That is, an alignment error can be discovered simply by checking for the mark P wit the CCD camera 40.

According to the embodiments of the present invention described above, the sensor (photo-coupler 38 or CCD camera 40) issues a signal (electric detection signal or video signal) to a controller C. The controller analyzes the signal to determine whether the (flat zones of the) wafers W are aligned. If the controller C determines that there is an alignment error, the controller C controls the transfer robot R1˜Rn and respective components of the wet cleaning equipment to prevent the alignment error from creating any of the aforementioned problems. The controller may also activate an alarm (visual or sound-based) to inform a worker of the alignment error.

As described above, according to the invention, the state of alignment of the wafers W is monitored as the wafers are transferred between the respective sections of the wet cleaning equipment, especially between those sections that include a slotted support onto which the wafers are lowered and from which the wafers are subsequently transferred. Thus, the wafers are assured to be aligned when received in the slots of the support. Accordingly, the wafers are prevented from being damaged during their subsequent transfer. Moreover, the wafers are transferred securely without the possibility of any of the wafers being dropped.

Finally, although the present invention has been described above with respect to the preferred embodiments thereof, the present invention is not so limited. Accordingly, changes and modifications to the disclosed embodiments, as will be apparent to those of ordinary skill in the art, are seen to be within the true spirit and scope of the invention as defined by the appended claims.

1. Wet cleaning equipment for use in cleaning wafers each having a flat zone at the outer periphery thereof, said equipment comprising:
a plurality of baths disposed adjacent one another in a line, each of said baths containing a solution used to perform a unit cleaning procedure on the wafers;
at least one transfer robot comprising a chuck configured to hold a plurality of wafers in an array as spaced from one another in one direction, said at least one transfer robot having a working envelope encompassing at least one of said baths and a sensing area located outside the bath, and said at least one transfer robot being operable to deliver the wafers to the at least one bath via said sensing area;
sensor means for issuing a signal indicative of whether the flat zones of the wafers are aligned in said one direction when the wafers are positioned by said at least one robot at said sensing area; and
a controller operatively connected to said sensor means and said at least one transfer robot so as to receive the signal issued by the sensor means and control said at least one transfer robot when the signal is indicative that the flat zones of the wafers held by said robot chuck are out of alignment.

2. The wet cleaning equipment of claim 1, wherein said sensor means comprises at least one photo-coupler including a light-emitting element that emits light along a light path extending in said one direction, and a light-detecting element.

3. The wet cleaning equipment of claim 2, wherein said at least one photo-coupler comprises a pair of said photo-couplers disposed side-by-side.

4. The wet cleaning equipment of claim 2, wherein said at least one photo-coupler comprises two pairs of photo-couplers, one of said pairs of photo-couplers disposed side-by-side at an upper portion of said sensing area, and the other of said photo-couplers disposed side-by-side at a lower portion of said sensing area.

5. The wet cleaning equipment of claim 1, and further comprising supports that extend vertically upright opposite each other at both sides of the at least one bath, and wherein said sensor means comprises sensor elements mounted to said supports, respectively.

6. The wet cleaning equipment of claim 5, wherein said sensor elements include a light-emitting element that emits light along a light path extending in said one direction, and a light-detecting element.

7. The wet cleaning equipment of claim 1, wherein said at least one transfer robot further includes a vertically extending support shaft that supports said robot chuck and is movable up and down to raise and lower the robot chuck, said support shaft being disposed at one side of the at least one bath, and further comprising a support that extends vertically upright opposite said support shaft at the other side of said at least one bath, and wherein said sensor means comprises sensor elements mounted to said support and said support shaft, respectively.

8. The system of claim 1, wherein said sensor means comprises a CCD (charge-coupled device) camera.

9. The system of claim 8, wherein said CCD camera is disposed at one side of the at least one bath, and further comprising a support disposed at the other side of the at least one bath, said support bearing a mark across the sensing area from the CCD camera.

10. The wet cleaning equipment of claim 1, wherein said at least one transfer robot further includes a vertically extending support shaft that supports said robot chuck and is movable up and down to raise and lower the robot chuck, said support shaft being disposed at one side of the at least one bath, and said sensor means comprises a CCD (charge coupled device) camera mounted to said support shaft.

11. The wet cleaning equipment of claim 10, and further comprising a support that extends vertically upright opposite said support shaft at the other side of said at least one bath, said support bearing a mark that can be picked up by said CCD camera when the flat zones of the wafers are aligned in said one direction while the wafers are positioned by said at least one robot at said sensing area.

12. The wet cleaning equipment of claim 1, and further comprising slotted wafer supports disposed in a lower portion of each of the baths, respectively.
